(19) United States
(12) Patent Application Publication
(10) Pub. No.: US 2006/0170647 A1
(43) Pub. Date: Aug. 3, 2006

(54) Electrophoretic display unit

(75) Inventors: Guofu Zhou, Eindhoven (NL); Johannes Petrus Van De Kamer, Heerlen (NL); Neculai Ailenei, Heerlen (NL); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Phillips Electronics N.V.

(21) Appl. No.: 10/564,531

(22) PCT Filed: Jul. 7, 2004
(86) PCT No.: PCT/IB04/51152

§ 371 Date: Jan. 12, 2006

(30) Foreign Application Priority Data
Jul. 15, 2003 (EP) 031021629

(51) Int. Cl. G09G 3/34

(52) U.S. Cl. 345/107

(57) ABSTRACT

Electophoretic display units (1) are driven with a relatively low amount of power and more efficiently by addressing the pixels (11) only once during a sequence of frame periods. Compared to addressing a pixel (11) each frame period, for signals having a duration of more than one frame period, a large amount of power is saved. During a sequence of frame periods formed by a time-interval (T₁-T₈), one or more reset pulses (R) or one or more driving pulses (Dr) are provided. The addressing of a line of pixels (11) can be skipped during a sequence of frame periods if all pixels (11) of the line of pixels (11) have to remain unchanged. Signals having a duration of two or more frame periods do not need to be supplied to the pixels (11) each frame period, but need to be supplied only once by addressing the pixels (11) only once during a sequence of frame periods.

The invention relates to an electrophoretic display unit, to a display device comprising an electrophoretic display unit, to a method for driving an electrophoretic display unit, to a computer program product for driving an electrophoretic display unit, and to a controller.

Examples of display devices of this type are: monitors, laptop computers, personal digital assistants (PDAs), mobile telephones and electronic books, electronic newspapers, and electronic magazines.

A prior art electrophoretic display unit is known from international patent application WO 99/53373. This patent application discloses an electronic ink display comprising two substrates, with one of the substrates being transparent and having a common electrode (also known as counter electrode) and with the other substrate being provided with pixel electrodes arranged in rows and columns. A crossing between a row and a column electrode is associated with a pixel. The pixel is formed between a part of the common electrode and a pixel electrode. The pixel electrode is coupled to the drain of a transistor, of which the source is coupled to the column electrode and of which the gate is coupled to the row electrode. This arrangement of pixels, transistors and row and column electrodes jointly forms an active matrix. A row driver (select driver) supplies a row driving signal or a selection signal for selecting a row of pixels and the column driver (data driver) supplies column driving signals or data signals to the selected row of pixels via the column electrodes and the transistors. The data signals correspond to data to be displayed, and form, together with the selection signal, a (part of a) driving signal for driving one or more pixels.

Furthermore, an electronic ink is provided between the pixel electrode and the common electrode provided on the transparent substrate. The electronic ink comprises multiple microcapsules with a diameter of about 10 to 50 microns. Each microcapsule comprises positively charged white particles and negatively charged black particles suspended in a fluid. When a positive field is applied to the pixel electrode, the white particles move to the side of the microcapsule directed to the transparent substrate, and the pixel becomes visible to a viewer. Simultaneously, the black particles move to the pixel electrode at the opposite side of the microcapsule where they are hidden from the viewer. By applying a negative field to the pixel electrode, the black particles move to the common electrode at the side of the microcapsule directed to the transparent substrate, and the pixel appears dark to a viewer. Simultaneously, the white particles move to the pixel electrode at the opposite side of the microcapsule where they are hidden from the viewer. When the electric fields are removed, the display unit remains in the acquired state and exhibits a bi-stable character.

To reduce the dependency of the optical response of the electrophoretic display unit on the history of the pixels, preset data signals are supplied before the data-dependent signals are supplied. These preset data signals comprise pulses representing energies which are sufficient to release the electrophoretic particles from a static state at one of the two electrodes, but which are too low to allow the electrophoretic particles to reach the other one of the electrodes. Because of the reduced dependency on the history of the pixels, the optical response to identical data will be substantially equal, regardless of the history of the pixels. The underlying mechanism can be explained by the fact that, after the display device is switched to a predetermined state, for example a black state, the electrophoretic particles come to a static state. When a subsequent switching to the white state takes place, the momentum of the particles is low because their starting speed is close to zero. This results in a high dependency on the history of the pixels resulting in a long switching time to overcome this high dependency. The application of the preset data signals increases the momentum of the electrophoretic particles and thus reduces the dependency resulting in a shorter switching time.

The time-interval required for driving all pixels in all rows once (by driving each row one after the other and by driving all columns simultaneously once per row) is called a frame and is of a fixed duration. Per frame, each pulse for driving a pixel requires, per row, a row driving action for supplying the row driving signal (the selection signal) to the row for selecting (driving) this row, and a column driving action for supplying the pulse, like for example a pulse of the preset data signals or a pulse of the data-dependent signals, to the pixel.

When updating an image, firstly a number of pulses of the preset data signals are supplied, further to be called preset pulses. Each preset pulse has a duration of one frame period. The first preset pulse, for example, has a positive amplitude, the second one a negative amplitude, and the third one a positive amplitude etc. Such preset pulses with alternating amplitudes do not change the gray value displayed by the pixel.

During one or more subsequent frames, the data-dependent signals are supplied, with a data-dependent signal having a duration of zero, one, two to for example fifteen frame periods. Thereby, a data-dependent signal having a duration of zero frame periods, for example, corresponds with the pixel displaying full black assuming that the pixel already displayed full black. In case the pixel displayed a certain gray value, this gray value remains unchanged when the pixel is driven with a data-dependent signal having a duration of zero frame periods, in other words when being driven with a driving pulse having a zero amplitude. A data-dependent signal having, for example, a duration of fifteen frame periods comprises fifteen driving pulses and results in the pixel displaying full white, and a data-dependent signal having a duration of one to fourteen frame periods, for example, comprises one to fourteen driving pulses and results in the pixel displaying one of a limited number of gray values between full black and full white.

As each frame period requires the sequential selecting of each row and providing the driving pulses for each pixel in a selected row, even in case of a data-dependent signal having a duration of two or more frame periods and comprising two or more driving pulses, a relatively large amount of power is required for driving the electrophoretic display unit.

The known electrophoretic display unit is disadvantageous, inter alia, due to the driving of the electrophoretic display unit requiring a relatively large amount of power.

It is an object of the invention, inter alia, to provide an electrophoretic display unit, in which the driving requires a relatively low amount of power. The invention is defined by the independent claims. The dependent claims define advantageous embodiments.

Further objects of the invention are, inter alia, providing a display device comprising an electrophoretic display unit in which the driving requires a relatively low amount of power, and providing a method for driving an electrophoretic display unit and a computer program product for driving an electrophoretic display unit, for use in (combination with) an electrophoretic display unit in which the driving requires a relatively low amount of power.

An electrophoretic display unit according to the invention comprises

an electrophoretic display panel comprising pixels;

drivers; and

a controller for controlling the drivers for addressing the pixels once during a sequence of frame periods.

By addressing the pixels only once during a sequence of frame periods comprising two or more frame periods, compared to driving the pixels twice or more during two or more frame periods, now energy is saved. The driving has become more efficient. Of course, this is just possible for data-dependent signals having a duration of two or more frame periods. The amount of power saved per pixel during the sequence of frame periods depends on the number of frame periods in this sequence of frame periods and is substantially equal to this number minus one, multiplied with 100%, and divided by this number.

An embodiment of an electrophoretic display unit according to the invention is defined by claim 2. The reset pulses precede the driving pulses to further improve the optical response of the electrophoretic display unit, by defining a fixed starting point (fixed black or fixed white) for the driving pulse. Alternatively, the reset pulses precede the driving pulses to further improve the optical response of the electrophoretic display unit, by defining a flexible starting point (black or white, to be selected in dependence of and closest to the gray value to be defined by the following driving pulses) for the driving pulses.

In an embodiment the sequence of frame periods is formed by a time-interval for providing the one or more driving pulses. Due to the driving pulses usually being provided as a combination of two or more driving pulses, which combination has a duration of two or more frame periods, when driving the electrophoretic display unit with the driving pulses, much power can be saved, by addressing the pixels only once during this time-interval.

In an embodiment the sequence of frame periods is formed by a time-interval for providing the one or more reset pulses. Due to the reset pulses usually being provided as a combination of two or more reset pulses, which combination has a duration of two or more frame periods, when driving the electrophoretic display unit with the reset pulses, much power can be saved, by addressing the pixels only once during this time-interval.

In an embodiment the sequence of frame periods is formed by a time-interval for providing the shaking pulses. If the frame rate of the electrophoretic display unit is larger than a frame rate required for the shaking pulses, it is advantageous to provide a shaking pulse only once during the sequence of frame periods in-order to save power by addressing the pixels only once during this time-interval.

An embodiment of an electrophoretic display unit according to the invention is defined by claim 6. By storing information about a time-interval forming the sequence of frame periods, a pulse can be supplied once per time-interval and automatically gets a duration equal to the time-interval.

In case of the pixels being arranged in lines of pixels, with the drivers comprising a line driver, the controller can skip the addressing of a line of the lines of pixels during the sequence of frame periods if all pixels of the line of pixels have to remain unchanged. The skipping of the addressing of the line of lines of pixels is very advantageous in that much power can be saved for all pixels of the line at once.

For example, the controller may drive the pixels only once in a first frame period of the sequence of frame periods whereby no driving signal for any pixel is changing its value between two subsequent frame periods in this sequence of frame periods.

The display device may be an electronic book, while the storage medium for storing information may be a memory stick, integrated circuit, a memory or other storage device for storing, for example, the content of a book to be displayed on the display unit.

Embodiments of method according to the invention and of a computer program product according to the invention correspond with the embodiments of an electrophoretic display unit according to the invention.

The invention is based upon an insight, inter alia, that signals having a duration of two or more frame periods do not need to be supplied to the pixels each frame period, and is based upon a basic idea, inter alia, that these signals need to be supplied only once by addressing the pixels only once during a sequence of frame periods.

The invention solves the problem, inter alia, of providing an electrophoretic display unit in which the driving requires a relatively low amount of power, and is advantageous, inter alia, in that power is saved and the driving has become more efficient.

These and other aspects of the invention will be apparent from and elucidated with reference to the embodiments(s) described hereinafter.

In the drawings:

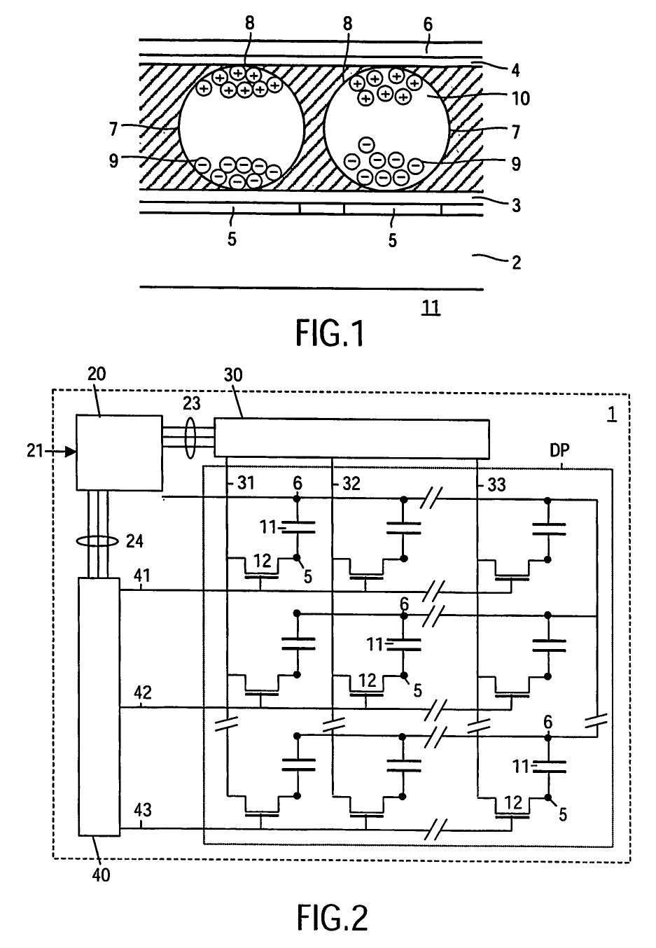

FIG. 1 shows (in cross-section) a pixel;

FIG. 2 shows diagrammatically an electrophoretic display unit;

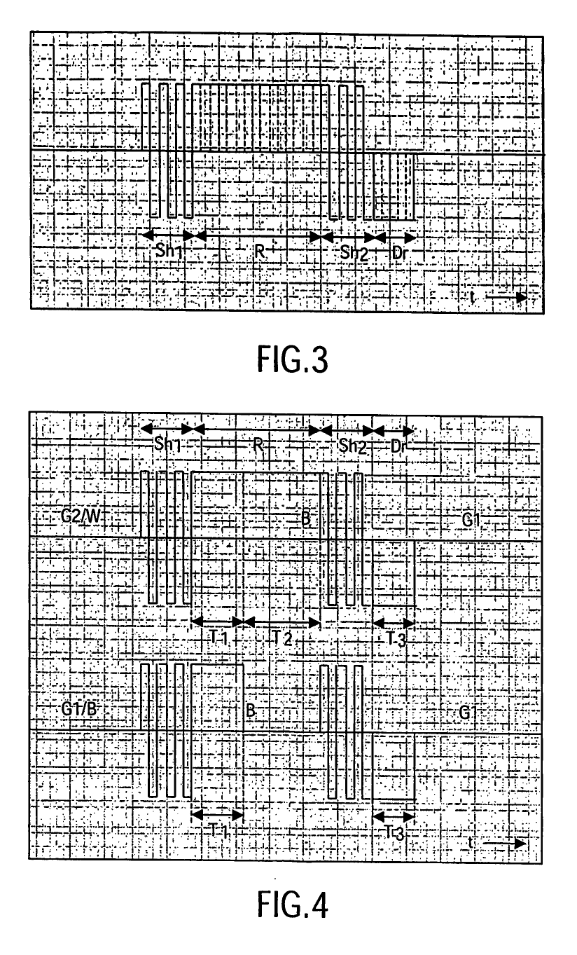

FIG. 3 shows a waveform for driving an electrophoretic display unit;

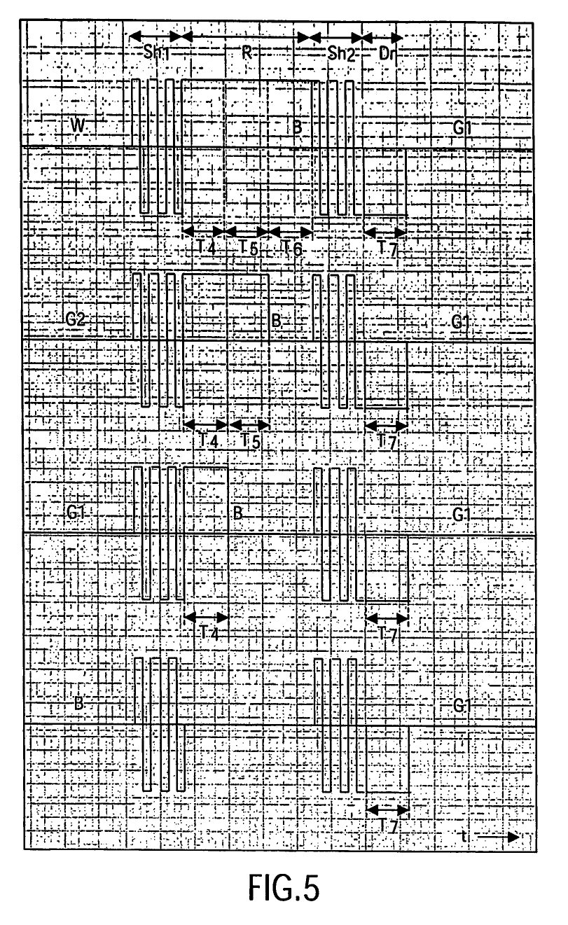

FIG. 4 shows two waveforms according to the invention;

FIG. 5 shows four waveforms according to the invention; and

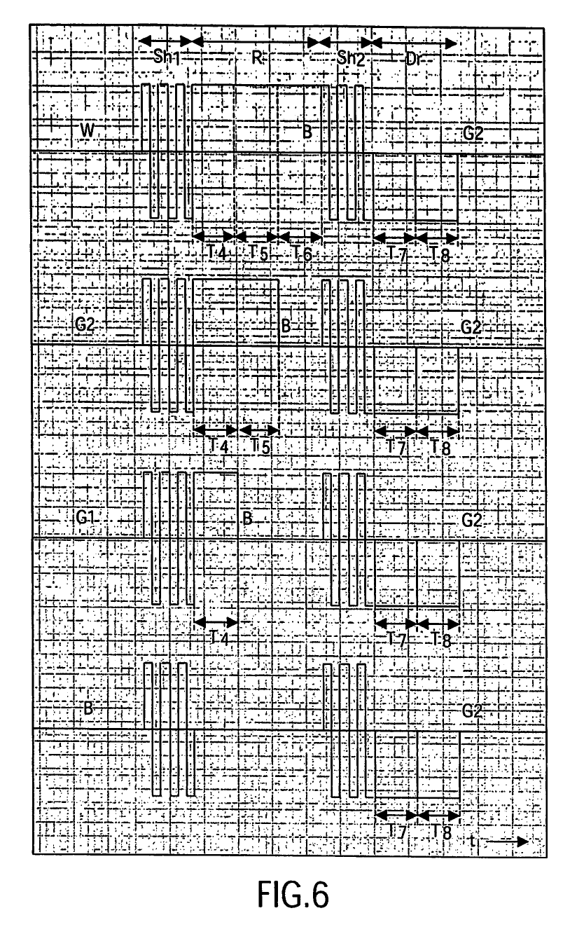

FIG. 6 shows four waveforms according to the invention.

The pixel 11 of the electrophoretic display unit shown in FIG. 1 (in cross-section) comprises a base substrate 2, an electrophoretic film (laminated on base substrate 2) with an electronic ink which is present between two transparent substrates 3,4 of, for example, polyethylene. One of the substrates 3 is provided with transparent pixel electrodes 5 and the other substrate 4 is provided with a transparent common electrode 6. The electronic ink comprises multiple microcapsules 7 of about 10 to 50 microns in diameter. Each microcapsule 7 comprises positively charged white particles 8 and negatively charged black particles 9 suspended in a fluid 10. When a positive field is applied to the pixel electrode 5, the white particles 8 move to the side of the microcapsule 7 directed to the common electrode 6, and the pixel becomes visible to a viewer. Simultaneously, the black particles 9 move to the opposite side of the microcapsule 7 where they are hidden from the viewer. By applying a negative field to the pixel electrode 5, the black particles 9 move to the side of the microcapsule 7 directed to the common electrode 6, and the pixel appears dark to a viewer (not shown). When the electric field is removed, the particles 8,9 remain in the acquired state and the display exhibits a bi-stable character and consumes substantially no power.

The electrophoretic display unit 1 shown in FIG. 2 comprises a display panel DP comprising a matrix of pixels 11 at the area of crossings of row or selection electrodes 41,42,43 and column or data electrodes 31,32,33. These pixels 11 are all coupled to a common electrode 6, and each pixel 11 is coupled to its own pixel electrode 5. The electrophoretic display unit 1 further comprises a row driver 40 coupled to the row electrodes 41,42,43 and a column driver 30 coupled to the column electrodes 31,32,33 and comprises per pixel 11 an active switching element 12. The electrophoretic display unit 1 is driven by these active switching elements 12 (in this example (thin-film) transistors). The row driver 40 consecutively selects the row electrodes 41,42,43, while the column driver 30 provides data signals to the column electrode 31,32,33. Preferably, a controller 20 first processes incoming data arriving via input 21 and then generates the data signals. Mutual synchronization between the column driver 30 and the row driver 40 takes place via drive lines 23 and 24. Selection signals from the row driver 40 select the pixel electrodes 5 via the transistors 12 of which the drain electrodes are electrically coupled to the pixel electrodes 5 and of which the gate electrodes are electrically coupled to the row electrodes 41,42,43 and of which the source electrodes are electrically coupled to the column electrodes 31,32,33. A data signal present at the column electrode 31,32,33 is simultaneously transferred to the pixel electrode 5 of the pixel 11 coupled to the drain electrode of the transistor 12. Instead of transistors, other switching elements can be used, such as diodes, MIMs, etc. The data signals and the selection signals together form (parts of) driving signals.

Incoming data, such as image information receivable via input 21 is processed by controller 20. Thereto, controller 20 detects an arrival of new image information about a new image and in response starts the processing of the image information received. This processing of image information may comprise the loading of the new image information, the comparing of previous images stored in a memory of controller 20 and the new image, the interaction with temperature sensors, the accessing of memories containing look-up tables of drive waveforms etc. Finally, controller 20 detects when this processing of the image information is ready.

Then, controller 20 generates the data signals to be supplied to column driver 30 via drive lines 23 and generates the selection signals to be supplied to row driver 40 via drive lines 24. These data signals comprise data-independent signals which are the same for all pixels 11 and data-dependent signals which may or may not vary per pixel 11. The data-independent signals comprise shaking pulses forming the preset pulses, with the data-dependent signals comprising one or more reset pulses and one or more driving pulses. These shaking pulses comprise pulses representing energy which is sufficient to release the electrophoretic particles 8, 9 from a static state at one of the two electrodes 5, 6, but which is too low to allow the particles 8, 9 to reach the other one of the electrodes 5, 6. Because of the reduced dependency on the history, the optical response to identical data will be substantially equal, regardless of the history of the pixels 11. So, the shaking pulses reduce the dependency of the optical response of the electrophoretic display unit on the history of the pixels 11. The reset pulse precedes the driving pulse to further improve the optical response, by defining a flexible starting point for the driving pulse. This starting point may be a black or white level, to be selected in dependence on and closest to the gray value defined by the following driving pulse. Alternatively, the reset pulse may form part of the data-independent signals and may precede the driving pulse to further improve the optical response of the electrophoretic display unit, by defining a fixed starting point for the driving pulse. This starting point may be a fixed black or fixed white level.

In FIG. 3, a waveform representing voltages across a pixel II as a function of time t is shown for driving an electrophoretic display unit 1. This waveform is generated using the data signals supplied via the column driver 30. The waveform comprises first shaking pulses Sh₁, followed by one or more reset pulses R, second shaking pulses Sh₂ and one or more driving pulses Dr. For example sixteen different waveforms are stored in a memory, for example a look-up table memory, forming part of and/or coupled to the controller 20. In response to data received via input 21, controller 20 selects a waveform for a pixel 11, and supplies the corresponding selection signals and data signals via the corresponding drivers 30,40 and via the corresponding transistors 12 to the corresponding pixels 11.

A frame period corresponds with a time-interval used for driving all pixels 11 in the electrophoretic display unit 1 once (by driving each row one after the other and by driving all columns simultaneously once per row). For supplying data-dependent or data-independent signals to the pixels 11 during frames, the column driver 30 is controlled in such a way by the controller 20 that all pixels 11 in a row receive these data-dependent or data-independent signals simultaneously. This is done row by row, with the controller 20 controlling the row driver 40 in such a way that the rows are selected one after the other (all transistors 12 in the selected row are brought into a conducting state). In case of data-independent signals, more than one row may be selected simultaneously.

During a first set of frames, the first and second shaking pulses Sh₁ and Sh₂ are supplied to the pixels 11, with each shaking pulse having a duration of one frame period. The starting shaking pulse for example has a positive amplitude, the next one a negative amplitude, and the next one a positive amplitude etc. Therefore, these alternating shaking pulses do not change the gray value displayed by the pixel 11, as long as the frame period is relatively short.

During a second set of frames comprising one or more frames periods, a combination of reset pulses R is supplied, further to be discussed below. During a third set of frames comprising one or more frames periods, a combination of driving pulses Dr is supplied, with the combination of driving pulses Dr either having a duration of zero frame periods and in fact being a pulse having a zero amplitude or having a duration of one, two to for example fifteen frame periods. Thereby, a driving pulse Dr having a duration of zero frame periods for example corresponds with the pixel 11 displaying full black (in case the pixel 11 already displayed full black; in case of displaying a certain gray value, this gray value remains unchanged when being driven with a driving pulse having a duration of zero frame periods, in other words when being driven with a pulse having a zero amplitude). The combination of driving pulses Dr having a duration of fifteen frame periods comprises fifteen subsequent pulses and for example corresponds with the pixel 11 displaying full white, and the combination of driving pulses Dr having a duration of one to fourteen frame periods comprises one to fourteen subsequent pulses and for example corresponds with the pixel 11 displaying one of a limited number of gray values between full black and full white.

The reset pulses R precede the driving pulses Dr to further improve the optical response of the electrophoretic display unit 1, by defining a fixed starting point (fixed black or fixed white) for the driving pulses Dr. Alternatively, reset pulses R precede the driving pulses Dr to further improve the optical response of the electrophoretic display unit, by defining a flexible starting point (black or white, to be selected in dependence of and closest to the gray value to be defined by the following driving pulses) for the driving pulses Dr.

As each pulse requires a driving action once per frame period, even if the pulse is a combination of reset pulses R or a combination of driving pulses Dr having a duration of two or more frame periods (and then comprising two or more subpulses directly following each other as shown in FIG. 3 by the dotted lines), the driving of the electrophoretic display unit 1 requires a relatively large amount of power.

FIG. 4 shows two waveforms for driving a pixel 11 according to the invention each representing voltages across the pixel 11. The upper graph shows a waveform according to the invention for changing the gray state of a pixel 11 from light gray G2 or white W to dark gray G1. After the first shaking pulses Sh₁, during a time-interval T₁ (comprising six frame periods), a first part of the combination of reset pulses R is generated by once supplying, at the beginning of time-interval T₁, a pulse to the pixel 11. Then, during a time-interval T₂ (comprising nine frame periods), a second part of the combination of reset pulses R is generated by once supplying, at the beginning of time-interval T₂, a pulse to the pixel 11. As a result, after the time-interval T₂, the pixel 11 is in a black state B, and the second shaking pulses Sh₂ are supplied which do not change the gray state of the pixel 11. Finally, after the second shaking pulses Sh₂, during a time-interval T₃ (comprising five frame periods), the combination of driving pulses Dr is generated by once supplying, at the beginning of time-interval T₃, a pulse to the pixel 11. As a result, the pixel 11 is now in a dark gray state G1. As the combination of reset pulses R and the combination of driving pulses Dr are generated by addressing the pixel 11 only once during the time-intervals T₁+T₂ and T₃ respectively and not each frame period, a large amount of power is saved.

The lower graph in FIG. 4 shows a waveform according to the invention for changing the gray state of a pixel 11 from dark gray G1 or black B to dark gray G1. After the first shaking pulses Sh₁, during a time-interval T₁, the combination of reset pulses R is generated by once supplying, at the beginning of time-interval T₁, a pulse to the pixel 11. As a result, after the time-interval T₁, the pixel 11 is in a black state B. During time-interval T₂, a pulse with a zero amplitude is supplied, and then the second shaking pulses Sh₂ are supplied which do not change the gray state of the pixel 11. Finally, after the second shaking pulses Sh₂, during a time-interval T₃, the combination of driving pulses Dr is generated by once supplying, at the beginning of time-interval T₃, a pulse to the pixel 11. As a result, the pixel 11 is now in a dark gray state G1.

If a first pixel 11 in a unit 1 requires a driving waveform according to the upper graph of FIG. 4 and a second pixel 11 requires a driving waveform according to the lower graph of FIG. 4, the controller 20 addresses all pixels 11 of the unit 1 at the start of the time-interval T₂. The first pixel 11 is re-addressed with the same voltage (upper graph), while the second pixel 11 is addressed with a zero voltage (lower graph).

FIG. 5 shows four waveforms for driving a pixel 11 according to the invention each representing voltages across the pixel 11. The upper graph shows a waveform according to the invention for changing the gray state of a pixel 11 from white W to dark gray G1. After the first shaking pulses Sh₁, during a time-interval T₄ (comprising five frame periods), a first part of the combination of reset pulses R is generated by once supplying, at the beginning of time-interval T₄, a pulse to the pixel 11. Then, during a time-interval T₅ (comprising five frame periods), a second part of the combination of reset pulses R is generated by once supplying, at the beginning of time-interval T₅, a pulse to the pixel 11, and during a time-interval T₆ (comprising five frame periods), a third part of the combination of reset pulses R is generated by once supplying, at the beginning of time-interval T₆, a pulse to the pixel 11. As a result, after the time-interval T₆, the pixel 11 is in a black state B, and the second shaking pulses Sh₂ are supplied which do not change the gray state of the pixel 11. Finally, after the second shaking pulses Sh₂, during a time-interval T₇ (comprising five frame periods), the combination of driving pulses Dr is generated by once supplying, at the beginning of time-interval T₇, a pulse to the pixel 11. As a result, the pixel 11 is now in dark gray state G1.

The second graph from above in FIG. 5 shows a waveform according to the invention for changing the gray state of a pixel 11 from light gray G2 to dark gray G1. After the first shaking pulses Sh₁, during the time-interval T₄, a first part of the combination of reset pulses R is generated by once supplying, at the beginning of time-interval T₄, a pulse to the pixel 11. Then, during the time-interval T₅, a second part of the combination of reset pulses R is generated by once supplying, at the beginning of time-interval T₅, a pulse to the pixel 11. As a result, after the time-interval T₅, the pixel 11 is in a black state B. During the time-interval T₆, a pulse with a zero amplitude is supplied, and then the second shaking pulses Sh₂ are supplied which do not change the gray state of the pixel 11. Finally, after the second shaking pulses Sh₂, during the time-interval T₇, the combination of driving pulses Dr is generated by once supplying, at the beginning of time-interval T₇, a pulse to the pixel 11. As a result, the pixel 11 is now in dark gray state 01.

The third graph from above in FIG. 5 shows a waveform according to the invention for changing the gray state of a pixel 11 from dark gray G1 to dark gray G1. After the first shaking pulses Sh₁, during the time-interval T₄, the combination of reset pulses R is generated by once supplying, at the beginning of time-interval T₄, a pulse to the pixel 11. As a result, after the time-interval T₄, the pixel 11 is in a black state B. During the time-intervals T₅ and T₆, pulses with a zero amplitude are supplied, and then the second shaking pulses Sh₂ are supplied which do not change the gray state of the pixel 11. Finally, after the second shaking pulses Sh₂, during the time-interval T₇, the combination of driving pulses Dr is generated by once supplying, at the beginning of time-interval T₇, a pulse to the pixel 11. As a result, the pixel 11 is now in dark gray state G1.

The lower graph in FIG. 5 shows a waveform according to the invention for changing the gray state of a pixel 11 from black B to dark gray G1. After the first shaking pulses Sh₁, because of the pixel 11 already being in the black state B, during the time-intervals T₄ and T₅ and T₆, pulses with a zero amplitude are supplied, and then the second shaking pulses Sh₂ are supplied which do not change the gray state of the pixel 11. Finally, after the second shaking pulses Sh₂, during the time-interval T₇, the combination of driving pulses Dr is generated by once supplying, at the beginning of time-interval T₇, a pulse to the pixel 11. As a result, the pixel 11 is now in dark gray state G1.

FIG. 6 shows four waveforms for driving a pixel 11 according to the invention each representing voltages across the pixel 11. The upper graph shows a waveform according to the invention for changing the gray state of a pixel 11 from white W to light gray G2. This upper graph corresponds with the upper graph in FIG. 5, apart from the fact that, after the second shaking pulses Sh₂, during the time-interval T₇ (comprising five frame periods), a first part of the combination of driving pulses Dr is generated, by once supplying, at the beginning of time-interval T₇, a pulse to the pixel 11, and during a time-interval T₈ (comprising five frame periods), a second part of the combination of driving pulses Dr is generated, by once supplying, at the beginning of time-interval T₈, a pulse to the pixel 11. As a result, the pixel 11 is now in light gray state G2.

The second and third graph from above in FIG. 6 and the lower graph in FIG. 6 correspond with the second and third graph from above in FIG. 5 and the lower graph in FIG. 5, apart from the fact that again the gray state of the pixel 11 is changed into light gray G2 and that, during the time-interval T₇ (comprising five frame periods), a first part of the combination of driving pulses Dr is generated, by once supplying, at the beginning of time-interval T₇, a pulse to the pixel 11, and during a time-interval T₈ (comprising five frame periods), a second part of the combination of driving pulses Dr is generated, by once supplying, at the beginning of time-interval T₈, a pulse to the pixel 11. As a result, the pixel 11 is now in light gray state G2.

Of course, the graphs in FIGS. 4, 5 and 6 are just examples to which many alternatives are possible without departing from the scope of the invention. The pixels 11 are addressed once during a sequence of frame periods, in other words the pixels 11 are driven once during any of the time-intervals, T₁-T₈, each interval comprising two or more frame periods.

Controller 20 comprises and/or is coupled to a memory (not shown) like, for example, a look-up table memory for storing information about a time-interval T₁, T₂,T₃,T₄,T₅,T₆,T₇,T₈ forming the sequence of frame periods during which the one or more reset pulses R and the one or more driving pulses Dr are to be provided. The reset pulses R and the driving pulses Dr can be supplied once per time-interval and automatically have their duration being equal to this time-interval.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. An electrophoretic display unit (1) comprising:
an electrophoretic display panel (DP) comprising pixels (11);
drivers (30, 40); and
a controller (20) for controlling the drivers (30, 40) for addressing the pixels (11) once during a sequence of frame periods.

2. An electrophoretic display unit (1) as claimed in claim 1, wherein the controller (20) is adapted to provide:
shaking pulses (Sh₁,Sh₂);
one or more reset pulses (R); and
one or more driving pulses (Dr).

3. An electrophoretic display unit (1) as claimed in claim 2, wherein the sequence of frame periods is formed by a time-interval (T₁,T₂,T₄,T₅,T₆) for providing the one or more reset pulses (R).

4. An electrophoretic display unit (1) as claimed in claim 2, wherein the sequence of frame periods is formed by a time-interval (T₃,T₇,T₈) for providing the one or more driving pulses (Dr).

5. An electrophoretic display unit (1) as claimed in claim 2, wherein the sequence of frame periods is formed by a time-interval for providing the shaking pulses (Sh₁,Sh₂).

6. An electrophoretic display unit (1) as claimed in claim 1, further comprising a memory coupled to the controller (20) for storing information about a time-interval (T₁,T₂,T₃,T₄,T₅,T₆,T₇,T₈) forming the sequence of frame periods.

7. An electrophoretic display unit (1) as claimed in claim 1, the pixels (11) being arranged in lines of pixels (11), the drivers (30,40) comprising a line driver (40), the controller (20) being arranged for skipping the addressing of a line of the lines of pixels (11) during the sequence of frame periods if all pixels (11) of the line of pixels (11) have to remain unchanged.

8. A display device comprising an electrophoretic display unit (1) as claimed in claim 1; and comprising a storage medium for storing information to be displayed.

9. A method for driving an electrophoretic display unit (1) comprising an electrophoretic display panel (DP) comprising pixels (11); and drivers (30, 40), the method comprising the step of:
controlling the drivers (30, 40) for addressing the pixels (11) once during a sequence of frame periods.

10. A computer program product for driving an electrophoretic display unit (1) comprising an electrophoretic display panel (DP) comprising pixels (11); and drivers (30, 40), the product comprising the function of:
controlling the drivers (30, 40) for addressing the pixels (11) once during a sequence of frame periods.

11. A controller (20) for controlling drivers (30, 40) for addressing pixels (11) of an electrophoretic display panel (DP) of an electrophoretic display unit (1), the controller (20) being adapted for addressing the pixels (11) once during a sequence of frame periods.
